(19) United States
(12) Patent Application Publication
(10) Pub. No.: US 2015/0185486 A1
(43) Pub. Date: Jul. 2, 2015

(54) HOLOGRAPHIC IMAGING ELEMENT OPERABLE TO GENERATE MULTIPLE DIFFERENT IMAGES OF AN OBJECT

(71) Applicant: The Regents of the University of California, Oakland, CA (US)

(72) Inventors: Kenneth A. Goldberg, Berkeley, CA (US); Iacopo Mochi, Berkeley, CA (US)

(21) Appl. No.: 14/627,180

(22) Filed: Feb. 20, 2015

Related U.S. Application Data
(63) Continuation of application No. PCT/US2013/056644, filed on Aug. 26, 2013.
(60) Provisional application No. 61/695,933, filed on Aug. 31, 2012.

(51) Int. Cl. G02B 27/10; G02B 5/18; G02B 5/32

(52) U.S. Cl. CPC G02B 27/1013; G02B 5/32; G02B 5/1895; G02B 27/1086

(57) ABSTRACT

This disclosure provides systems, methods, and apparatus related to imaging elements. In one aspect, a system includes an electromagnetic radiation source, a detector, and an imaging element. The electromagnetic radiation source is configured to generate electromagnetic radiation. The imaging element is configured to simultaneously project a plurality of images of an object onto the detector after the electromagnetic radiation interacts with the object. Each of the plurality of images of the object has different properties from others of the plurality of images.

### RELATED APPLICATIONS

This application is a continuation of International Application No. PCT/US2013/056644, filed Aug. 26, 2013, which claims priority to U.S. Provisional Patent Application No. 61/695,933, filed Aug. 31, 2012, both of which are herein incorporated by reference. This application is related to U.S. Pat. No. 6,963,395, which is herein incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### TECHNICAL FIELD

This disclosure relates generally to imaging elements, and more particularly to holographic imaging elements, hybrid lenses, and hybrid zone plates.

### BACKGROUND

An example of a conventional refractive lens is an optical device which transmits light and refracts light, and may converge of diverge a light beam, depending on its configuration. Conventional lenses also include reflective lenses. In some imaging applications, conventional refractive or reflective lenses can be replaced with holographic lenses that serve the same or similar functions.

One area where holographic lenses have found broad use is in short-wavelength imaging. At short wavelengths (e.g., extreme ultraviolet (EUV), soft x-ray, x-ray, etc.), high-quality conventional lenses are often prohibitively difficult or are expensive to fabricate. In contrast, the technology for fabricating holographic lenses has steadily improved.

Originally, holograms were created photographically by interfering light fields from a single coherent light source. Today, holographic optical elements (HOE) may be created from lithographically fabricated fine patterns that modify the impinging light field in specific ways, operating either in transmission or in reflection. One familiar example of these holographic lenses is a zone plate, which can replicate the behavior of a single lens objective in numerous EUV, soft x-ray, and x-ray microscopes around the world; that is, a zone plate is a device used to focus light or other electromagnetic radiation. Unlike conventional lenses, however, zone plates use diffraction instead of refraction.

In some imaging applications, bright field and dark field images may be recorded. The concepts of bright field and dark field imaging have been known to microscope makers and users for decades. Pupil size (i.e., solid angle) and shape control the imaging properties of lenses in an imaging system, including, for example, microscopes used in a broad range of light wavelengths. When a microscope design uses a conventional pupil shape (e.g., circular) and illumination aligned with the central axis of the pupil, the imaging mode is known as bright field (BF); these image forming properties are familiar to many people. However, when the center portion of such a pupil is intentionally blocked, the lowest spatial frequencies of the image (i.e., large feature sizes) are suppressed, and the higher spatial frequencies in the image (i.e., small features) can be enhanced. This imaging mode, which accentuates the edges and smaller features of the object, is called dark field (DF).

In some other imaging applications, in particular those relevant for research in photolithography, a standard mode of data collection is to record images through-focus, meaning that a series of images is generated with a small relative focal shift applied to each. For example, in EUV photomask imaging applications, capturing through-focus series may be used to help guarantee that a best focus image has been recorded for each feature of interest. In addition, the image contrast and behavior of the aerial image in and out of focus are primary areas of interest in evaluating mask properties.

### SUMMARY

In some embodiments, a hybrid zone plate holographically combines the features of two zone plates with different pupil properties, enabling the simultaneous collection of bright field and dark field images. Although the image intensity of each of the images is reduced as the beam is divided, this advance can improve the sensitivity and versatility of microscopes, which typically operate in one mode or the other. Short-wavelength microscopes, which often use one mode or the other, may use both imaging modes simultaneously. In some embodiments, a hybrid zone plate has the potential to utilize a large detector area, which may include unused, out of focus portions of the field of view due to a tilted focal plane in an off-axis geometry.

In some embodiments, a hybrid zone plate holographically combines the features of multiple zone plates with various properties into the same pupil, thus enabling multiple images to be projected and recorded at once. In some embodiments, a hybrid zone plate simultaneously projects multiple images with different, independent defocus values. Although the intensity scales downward with the number of image divisions, a hybrid zone plate can speed up data collection and minimize the uncertainties that arise from illumination non-uniformities and other motion-related effects. In some embodiments, a hybrid zone plate has the potential to make full use of the large detector area, which may include unused portions of the field of view that serve for navigation.

One innovative aspect of the subject matter described in this disclosure can be implemented an optical device including an imaging element configured to interact with electromagnetic radiation of specific wavelengths and configured to divide a first wavefront of the electromagnetic radiation into a plurality of separate wavefronts. Each of the plurality of separate wavefronts includes imaging information of an object configured to generate an image of the object. Each of the images of the object has different properties compared to other images.

In some embodiments, each of the plurality of separate wavefronts is spatially separated when projected onto a detector. In some embodiments, a first of the plurality of separate wavefronts includes bright field imaging information configured to generate a bright field image of the object, and a second of the plurality of separate wavefronts includes dark field imaging information configured to generate a dark field image of the object. In some embodiments, each of the plurality of separate wavefronts includes imaging information at different defocus values configured to generate a plurality of images of the object at different defocus values. In some embodiments, one image of the plurality of images is in focus.

In some embodiments, the imaging element comprises a holographic imaging element. In some embodiments, the imaging element comprises a holographic imaging element combined with a lens in a single device. In some embodiments, the imaging element comprises a hybrid zone plate. In some embodiments, the hybrid zone plate includes a plurality of overlapping lens patterns. In some embodiments, each of the plurality of overlapping lens patterns generates one of the plurality of separate wavefronts.

Another innovative aspect of the subject matter described in this disclosure can be implemented a system including an electromagnetic radiation source, a detector, and an imaging element. The electromagnetic radiation source is configured to generate electromagnetic radiation. The imaging element is configured to simultaneously project a plurality of images of an object onto the detector after the electromagnetic radiation interacts with the object. Each of the plurality of images of the object has different properties from others of the plurality of images.

In some embodiments, the imaging element is configured to divide a first wavefront of the electromagnetic radiation into a plurality of separate wavefronts. Each of the plurality of separate wavefronts generates each of the plurality of images of the object. In some embodiments, each of the plurality of separate wavefronts includes different imaging information of the object. In some embodiments, a first of the plurality of separate wavefronts includes bright field imaging information configured to generate a bright field image of the object on the detector, and a second of the plurality of separate wavefronts includes dark field imaging information configured to generate a dark field image of the object on the detector. In some embodiments, each of the plurality of separate wavefronts includes imaging information at a different defocus value configured to generate a plurality of images of the object at different defocus values on the detector.

In some embodiments, the imaging element is incorporated with a zone plate or a lens in a single element. In some embodiments, the imaging element comprises a zone plate and includes a plurality of overlapping lens patterns. In some embodiments, each of the plurality of overlapping lens patterns generates one of the plurality of images of the object.

In some embodiments, the imaging element is configured to project each of the plurality of images of the object onto a separate region of the detector. In some embodiments, the detector comprises a charge coupled device or a micro-channel plate detector.

In some embodiments, the plurality of images includes a bright field image and a dark field image of the object. In some embodiments, each image of the plurality of images is at a different defocus value. In some embodiments, one image of the plurality of images is in focus.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a schematic illustration of an imaging system.

FIG. 2 shows an example of a schematic illustration of an imaging system.

FIG. 3 shows example of schematic representations of the sub-lenses that are combined to form a hybrid lens.

FIG. 4 shows an example of a schematic on-axis hybrid zone plate design to illustrate how the lens pattern calculation is made.

FIG. 5 shows examples of schematic illustrations of geometries of an object, a hybrid zone plate, and a detector.

FIG. 6 shows an example of a BF and DF hybrid zone plate configured to generate a deflected central portion and examples of simulated images.

FIG. 7 shows an example of a BF and DF hybrid zone plate configured to generate a deflected central portion and a scaled BF amplitude and examples of simulated images.

FIG. 8 shows an example of a BF and DF hybrid zone plate configured to generate a reduced amplitude in the central portion and examples of simulated images.

FIG. 9 shows an example of an illustration of the full image area recorded by a detector (the large square), the illuminated portion (the light circle), and the useful data region, at the center.

FIG. 10 shows examples of illustrations to aid in understanding the hybrid zone plate.

FIG. 11 shows an example of a schematic illustration of an on-axis version of a hybrid zone plate.

FIG. 12 shows examples of schematic illustrations of geometries of an object, a hybrid zone plate, and a detector.

FIG. 13 shows an example of a basic off-axis zone plate and simulated images.

FIG. 14 shows an example of a hybrid zone plate configured to generate three images with vertical displacement and defocus and examples of simulated images.

FIG. 15 shows an example of a hybrid zone plate configured to generate nine images with grid displacement and fixed focus and examples of simulated images.

FIG. 16 shows an example of a hybrid zone plate configured to generate nine images with grid displacement and varying focus and examples of simulated images.

FIG. 17 shows an example of a hybrid zone plate configured to generate sixteen images with grid displacement and varying focus and examples of simulated images.

FIG. 18 shows an example of a hybrid zone plate configured to generate seven images with hexagonal grid displacement and varying focus and examples of simulated images.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

### INTRODUCTION

A lens is an optical element that can project an image of an illuminated object. For example, if the object is a single point of light, the lens may project a point-like image. A holographic lens does the same thing that a conventional lens does, but it uses the properties of diffraction to bend and focus light, rather than refraction (e.g., with glass lenses) or reflection (e.g., with curved mirrors).

Holographic lenses with specific patterns (i.e., specific lens patterns) can be designed and produced with high accuracy using nanofabrication. They can be small and thin, and they can be used in combination with other imaging elements, such as filters and other lenses, for example. In some applications, such as EUV applications, for example, a holographic lens can cost much less a conventional lens of similar quality. Holographic lenses, however, have a wavelength-dependence and may be less efficient than conventional lenses.

For example, a lens pattern of a holographic lens may be a pattern in a material that blocks electromagnetic radiation of specific wavelengths and defines open regions that allow transmission of electromagnetic radiation, with the pattern being specified such that the electromagnetic radiation constructively interferes at a focal point, creating an image there. Each lens pattern may have its own focal point. A holographic lens can also operate in a reflective mode, with a lens pattern being a pattern in a material that reflects electromagnetic radiation of specific wavelengths and defines open regions that allow absorption of electromagnetic radiation, with the pattern being specified such that the electromagnetic radiation constructively interferes at a focal point

Because the lens pattern of a holographic lens may be specified, multiple lens patterns may be included with a single holographic lens. The multiple lens patterns can be combined in a single, overlapping design pattern, with the multiple lens patterns occupying the same pupil. Such a holographic lens that includes multiple lens patterns may project an image of a single point of light as multiple, spatially separate images, with each of the images having different properties. That is, a holographic lens including a plurality of lens patterns may have a plurality of focal points, with each lens pattern having a separate focal point.

### Imaging Element and System

An imaging element configured to simultaneously project multiple images of a single object such that each image includes different information is described herein. The images generated by such an imaging element can be analyzed either as a group or individually. Such an imaging element can be used with different wavelengths of electromagnetic radiation, including infrared light (wavelengths of about 1 mm to 700 nm), visible light (wavelengths of about 740 nm to 380 nm), ultraviolet light (UV, wavelengths of about 400 nm to 10 nm), extreme ultraviolet radiation (EUV, wavelengths of about 120 nm to 10 nm), and x-rays (wavelengths of about 10 nm to 0.1 nm, including soft x-rays).

An imaging element may be used in which different views or properties of the same object can be simultaneous imaged. For example, in some embodiments, an imaging element may be used to simultaneously generate a bright field image and a dark field image. In some embodiments, this may enhance detection sensitivity or data analysis. As another example, in some embodiments, an imaging element may be used to simultaneously generate multiple images with a varying amount of defocus in each image.

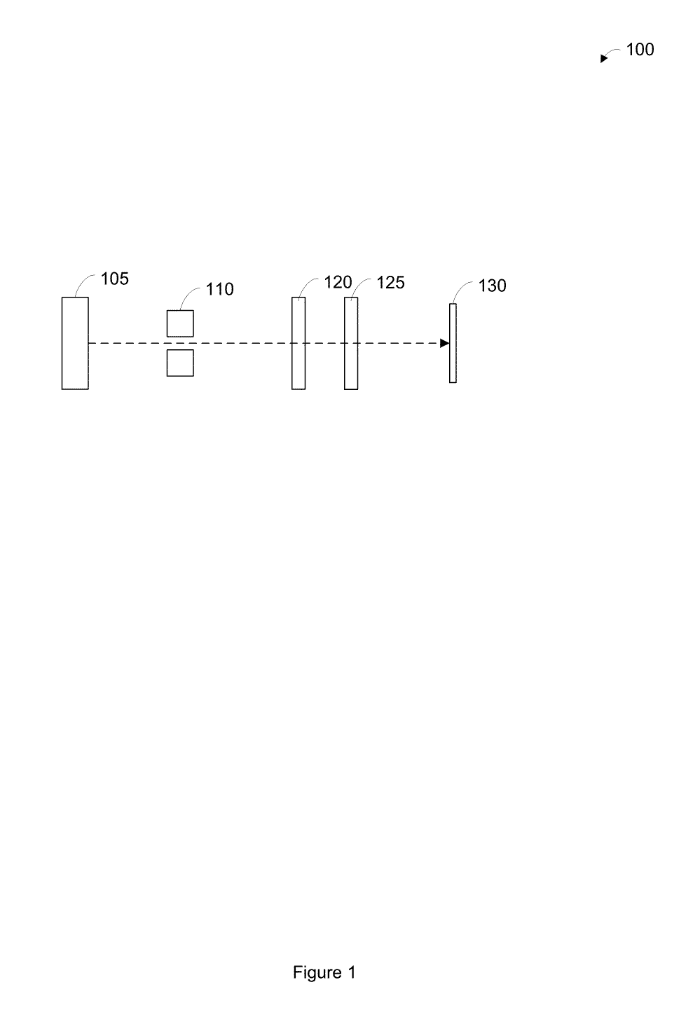

FIG. 1 shows an example of a schematic illustration of an imaging system. An imaging system 100 includes an electromagnetic radiation source 105, a stage 110 configured to hold an object to be imaged, an imaging element 120, a lens 125, and a detector 130. The imaging system 100 is in a transmission configuration; i.e., electromagnetic radiation from the electromagnetic radiation source 105 is transmitted through the object to be imaged. In some embodiments, an imaging system 100 may be configured in a reflection configuration, in which electromagnetic radiation is reflected from a surface of the object to be imaged. In some embodiments, the imaging element 120 receives electromagnetic radiation after the electromagnetic radiation interacts with the object to be imaged.

In some embodiments, the imaging element 120 may an integral part of the imaging system 100. In some embodiments, the imaging element 120 may be able to be removed from the imaging system 100 so that an image or images may be formed without using the imaging element 120. In some embodiments, the lens 125 may include a plurality of separate lenses.

In some embodiments, the electromagnetic radiation source 105 may generate EUV radiation, soft x-rays, or x-rays. In some embodiments, for EUV, soft x-ray, or x-ray wavelength imaging, the imaging element 120 may include a holographic imaging element which may include lens patterns formed in a thin film of metal of sheet of metal, such as gold or nickel, for example. The thin film of metal can block the EUV radiation, soft x-rays, and x-rays, and open regions in the thin film of metal allow for transmission of the EUV radiation, soft x-rays, or x-rays. In some embodiments, the thin film of metal may be about 100 nm to 1 micron thick, depending in part on the wavelength of radiation generated by the electromagnetic radiation source 105. In some embodiments, the imaging element 120 may include a support membrane comprising silicon or silicon nitride, for example. In some embodiments, the support membrane may be about 50 nm to 150 nm thick, or about 100 nm thick. The thin film of metal may be disposed on the support membrane, which may impart mechanical strength or rigidity to the thin film of metal. A support membrane may also aid in the fabrication of the imaging element 120 comprising a thin film of metal.

In some embodiments, for EUV, soft x-ray, and x-ray wavelength imaging, the lens 125 may comprise a zone plate. The characteristics of a zone plate are known by a person having ordinary skill in the art.

In some embodiments, the electromagnetic radiation source 105 may generate infrared light or visible light. In some embodiments, for visible light, the imaging element 120 may comprise a holographic imaging element comprising an optical glass or an optical plastic. The optical glass or optical plastic may include a lens pattern on a surface of the optical glass or optical plastic. The optical glass or optical plastic allows for transmission of the electromagnetic radiation used by the imaging system 100. The lens pattern may be absorbing or reflective to the electromagnetic radiation used by the imaging system 100.

In some embodiments, for visible light, the lens 125 may comprise a conventional lens (e.g., a concave lens or a convex lens) comprising an optical glass or an optical plastic. In some embodiments, for visible light, the lens 125 may comprise a holographic lens or a zone plate. In some embodiments, a holographic lens may be configured to replicate the performance of a conventional lens, using diffraction rather than refraction to focus the incident light.

In some embodiments, the detector 130 may include a charge coupled device (CCD) or a micro-channel plate detector. In some embodiments, the detector 130 may include a spatially sensitive recording media (e.g., film) that is sensitive to the wavelength of radiation generated by the electromagnetic radiation source. In some embodiments, the detector 130 may include a plurality of detectors.

In the imaging system 100, the lens 125 may be used for focusing (e.g., imaging) electromagnetic radiation and the imaging element 120 may be used for wavefront division, as described further below. In some embodiments, the imaging element 120 is configured to simultaneously project a plurality of images of an object onto the detector 130 after the electromagnetic radiation interacts with the object. Each of the plurality of images of the object may have different properties from others of the plurality of images.

In some embodiments, an imaging element 120 may include lens patterns of different pupil shapes for bright field and dark field imaging. In some embodiments, an imaging element 120 may include lens patterns of different defocus values for simultaneously imaging an object at the different defocus values.

For example, in some embodiments, the imaging element 120 may be configured to divide a first wavefront of the electromagnetic radiation into a plurality of separate wavefronts. Each of the plurality of wavefronts may generate each of the plurality of images of the object. In some embodiments, each of the plurality of separate wavefronts includes different imaging information of the object. A wavefront including imaging information will generate a specific image of an object; different images (e.g., bright field images, dark field images, images at different defocus values) will generated by wavefronts including different imaging information.

In some embodiments, a first of the plurality of separate wavefronts includes bright field imaging information configured to generate a bright field image of the object on the detector 130. A second of the plurality of separate wavefronts includes dark field imaging information configured to generate a dark field image of the object on the detector 130. Thus, such an imaging element 120 can simultaneously generate bright field and dark field images of an object.

In some embodiments, each of the plurality of separate wavefronts includes imaging information at a different defocus value configured to generate a plurality of images of the object at different defocus values on the detector 130. Thus, such an imaging element 120 can simultaneously generate a plurality of images of an object at different focus values. In some embodiments, one image of the plurality of images is in focus.

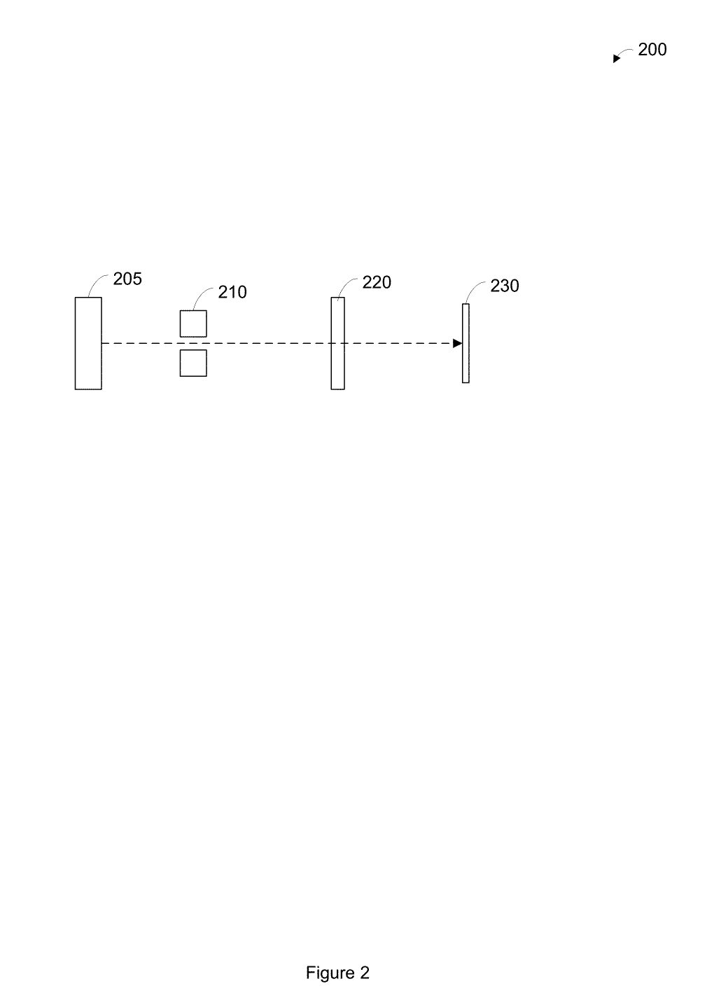

FIG. 2 shows an example of a schematic illustration of an imaging system. An imaging system 200 includes an electromagnetic radiation source 205, a stage 210 configured to hold an object to be imaged, an imaging element 220, and a detector 230. The imaging system 200 is in a transmission configuration; i.e., electromagnetic radiation from the electromagnetic radiation source 205 is transmitted through the object to be imaged. In some embodiments, an imaging system 200 may be configured in a reflection configuration, in which electromagnetic radiation is reflected from a surface of the object to be imaged. In some embodiments, the imaging element 220 receives electromagnetic radiation after the electromagnetic radiation interacts with the object to be imaged.

In some embodiments, the imaging system 200 may include components similar to the components of the imaging system 100. For example, in some embodiments, the electromagnetic radiation source 205 may generate infrared light, visible light, EUV radiation, soft x-rays, or x-rays. In some embodiments, the detector 230 may include a CCD or a micro-channel plate detector. In some embodiments, the detector 230 may include a spatially sensitive recording media (e.g., film) that is sensitive to the wavelength of radiation generated by the electromagnetic radiation source. In some embodiments, the detector 230 may include a plurality of detectors.

In some embodiments, the imaging element 220 may be a hybrid lens or a hybrid zone plate. The hybrid lens or hybrid zone plate may include features of the imaging element 120 and features of the lens 125, as described with respect to FIG. 1. In the imaging system 200, the hybrid lens or hybrid zone plate may be used both for focusing (e.g., imaging) electromagnetic radiation and for wavefront division, as described further below. In some embodiments, the imaging element 220 is configured to simultaneously project a plurality of images of an object onto the detector 230 after the electromagnetic radiation interacts with the object. Each of the plurality of images of the object may have different properties from others of the plurality of images.

In some embodiments, an imaging element 220 including a hybrid zone plate may combine zone plates of different pupil shapes into a single zone plate for bright field and dark field imaging. In some embodiments, an imaging element 220 including a hybrid zone plate may combine zone plates of different defocus values into a single zone plate for simultaneously imaging of an object at the different defocus values.

In some embodiments, a hybrid zone plate may include a plurality of overlapping lens patterns. A lens pattern formed by a plurality of overlapping lens patterns may be determined using the formula described in Example 1 and Example 2, below. In some embodiments, each of the plurality of overlapping lens patterns generates one of a plurality of images of the object.

In some embodiments, a hybrid zone plate may include lens patterns formed in a thin film of metal or a sheet of metal, such as gold or nickel, for example. The thin film of metal can block the EUV radiation, soft x-rays, or x-rays, and open regions in the thin film of metal allow for transmission of the EUV radiation, soft x-rays, or x-rays. In some embodiments, the thin film of metal may be about 100 nm to 1 micron thick, depending in part on the wavelength of radiation generated by the electromagnetic radiation source 205. In some embodiments, the imaging element 220 may include a support membrane of comprising silicon or silicon nitride, for example. In some embodiments, the support membrane may be about 50 nm to 150 nm thick, or about 100 nm thick. The thin film of metal may be disposed on the support membrane, which may impart mechanical strength or rigidity to the thin film of metal. A support membrane may also aid in the fabrication of a hybrid zone plate comprising a thin film of metal.

In some embodiments, an imaging element 220 including a hybrid lens may combine a conventional lens and a holographic imaging element in a single element. In some embodiments, the hybrid lens may comprise an optical glass or an optical plastic. In some embodiments, the optical glass or an optical plastic may form a converging lens (e.g., a biconvex lens or a plano-convex lens). In some embodiments, the optical glass or optical plastic may include a lens pattern on a surface or a curved surface of the optical glass or optical plastic. The optical glass or optical plastic allows for transmission of the electromagnetic radiation used by the imaging system. The lens pattern may be absorbing or reflective to the electromagnetic radiation used by the imaging system.

In some embodiments, the imaging element 220 may be configured to divide a first wavefront of the electromagnetic radiation into a plurality of separate wavefronts. Each of the plurality of wavefronts may generate each of the plurality of images of the object. In some embodiments, each of the plurality of separate wavefronts includes different imaging information of the object.

In some embodiments, a first of the plurality of separate wavefronts includes bright field imaging information configured to generate a bright field image of the object on the detector 230. A second of the plurality of separate wavefronts includes dark field imaging information configured to generate a dark field image of the object on the detector 230. Thus, such an imaging element 220 can simultaneously generate bright field and dark field images of an object.

In some embodiments, each of the plurality of separate wavefronts includes imaging information at a different defocus value configured to generate a plurality of images of the object at different defocus values on the detector 230. Thus, such an imaging element 220 can simultaneously generate a plurality of images of an object at different focus values. In some embodiments, one image of the plurality of images is in focus.

As known by one of ordinary skill in the art, holographic lenses/zone plates can be lithographically fabricated using, for example, electron-beam lithography. The pattern design of a zone plate may be drawn or laid out in a specific manner. The pattern design may include regions opaque to the electromagnetic radiation used in the imaging system and regions transparent to the electromagnetic radiation used in the imaging system. A holographic imaging element may also be lithographically fabricated using, for example, electron-beam lithography.

The following examples are intended to be examples of embodiments disclosed herein, and are not intended to be limiting. The principles set forth in the examples below are applicable to imaging systems and imaging elements (i.e., holographic imaging elements, hybrid lenses, and hybrid zone plates) configured to operate at wavelengths across the electromagnetic spectrum (e.g., from infrared light to x-rays).

### Example 1

A hybrid zone plate for mask blank inspection using the Actinic Inspection Tool (AIT) at Lawrence Berkeley National Laboratory is described below. The AIT is an EUV (13 nm wavelength) photomask microscope that operates at the Advanced Light Source at Lawrence Berkeley National Laboratory and uses a zone plate as a high-magnification objective lens. One function of a hybrid zone plate described below is to image defects using bright field imaging and dark field imaging simultaneously with the charge-coupled device (CCD) camera geometry used in the AIT. Previous investigations have shown the importance of both bright field and dark field imaging in the detection of amplitude defects and phase defects on EUV masks. Pairing these two modes of operation, however, has been a challenging aspect of system design, and most planned or operating systems choose one mode or the other. With a hybrid zone plate, both modes are used simultaneously, enhancing the potential defect detection sensitivity of mask inspection tools.

For heuristic purposes, two related concepts are presented to describe variations of a hybrid lens. Imagine that a lens with a circular pupil is divided into two regions: a smaller-diameter circular portion at the center of the original pupil, and an annular ring that surrounds it. The original lens is the superposition of these two sub-lenses, and its performance can be described by adding the properties of both lenses together. Yet individually, the imaging properties of the two sub-lenses would be quite different than when they are combined. The inner section performs like a BF lens with a smaller numerical aperture, while the annular portion performs like a DF lens, with a central obscuration equal to the smaller circular lens.

Now suppose that each sub-lens is given a different angular deviation produced by a phase-wedge or tilt. It is then possible to spatially separate the images produced by the BF lens and the DF lens so that they do not overlap. The two lens images may then be projected onto a single detector (e.g., a charge-coupled device (CCD) camera), enabling side-by-side BF and DF images to be recorded simultaneously. Alternatively, two lens images may then be projected onto two separated detectors.

More specifically, a hybrid zone plate as described in this example is a holographic lens that includes two or more overlapping lens patterns, A and B, where each lens pattern can project a spatially separate image onto one or more detectors. Lens A is a BF lens (which in the absence of lens B may be a conventional zone plate). Lens B is a DF lens, with its center portion obscured. The two lenses focus light in separate directions so the images do not overlap on the detector, and they can be analyzed either separately or together. One aspect of such a hybrid zone plate is that the two lenses occupy the same full pupil diameter, and they rely on the holographic principle to exist simultaneously.

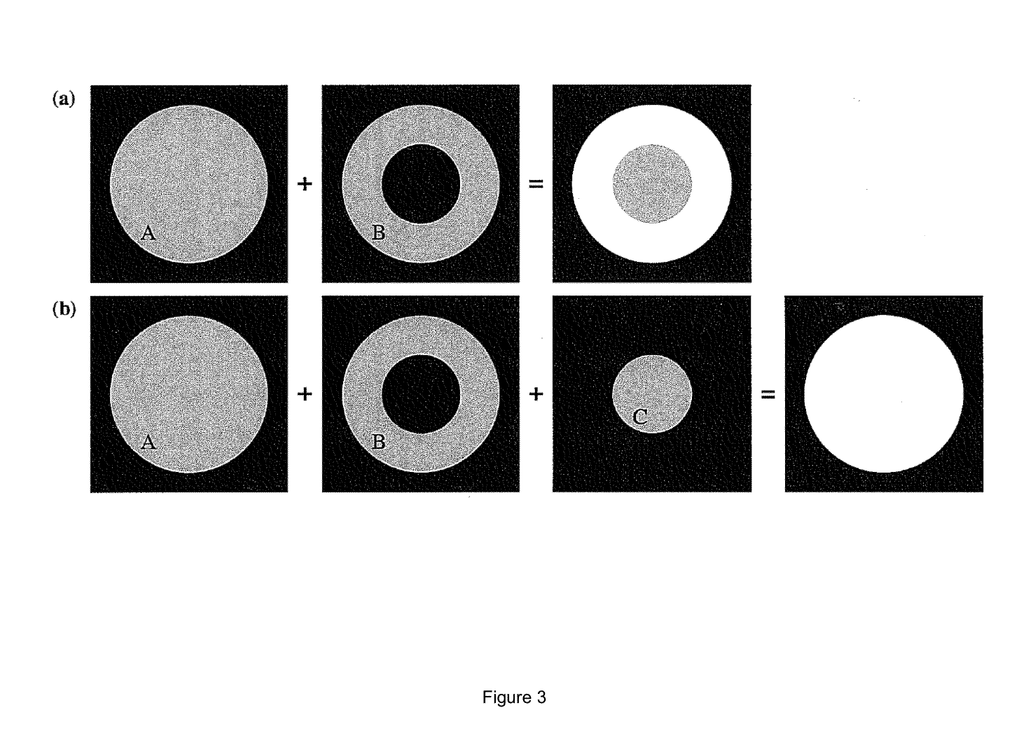

Consider the schematic pupil designs shown in FIG. 3. The design attempts to achieve a uniform pupil weighting across the whole circular pupil for lens A, and across an annular region for lens B. In the central region where lens B has no transmission, the design needs to intentionally decrease the transmission amplitude of the combined system so that lens A will have uniform transmission across the whole disk. The relative transmission of the central region can be set arbitrarily by adjusting the line-to-space ratio (i.e., duty cycle) of the lens. This configuration is shown in (a), where the gray level corresponds to the relative brightness, or transmission amplitude, of each sub-lens. An alternative strategy is shown in (b). Here an additional lens, lens C, is added, and covers the central region of the pupil, and which directs light away from the other two images. In this design, each point in the pupil belongs to two lenses, so the intensity may be balanced to achieve a uniform lens A transmission profile.

In the measurement of a bright, reflective surface, such as an EUV mask blank, BF images are expected to have a much higher peak intensity than DF images. When both images are projected onto the same detector, there could be some difficulty finding an exposure time or signal level that is appropriate. For this reason, the transmission amplitude of lens A may be reduced by adjusting its duty cycle, for example.

Some holographic imaging elements may be generated with complex mathematical algorithms. In contrast, a hybrid zone plate pattern may be calculated deterministically, based on the object and image positions, and the desired pupil shapes. Following the holographic principle, the calculation mathematically determines the interference pattern that would be formed in the lens plane if each of the projected images were back-propagated to that plane and were allowed to interfere with a single spherical wave emanating from the object position. The relative weighting (i.e., amplitude) of the object wave can be selected to optimize the image intensity. Once the interference has been calculated, the pattern can be binarized (i.e., made black and white, or transparent and opaque) for fabrication, if needed.

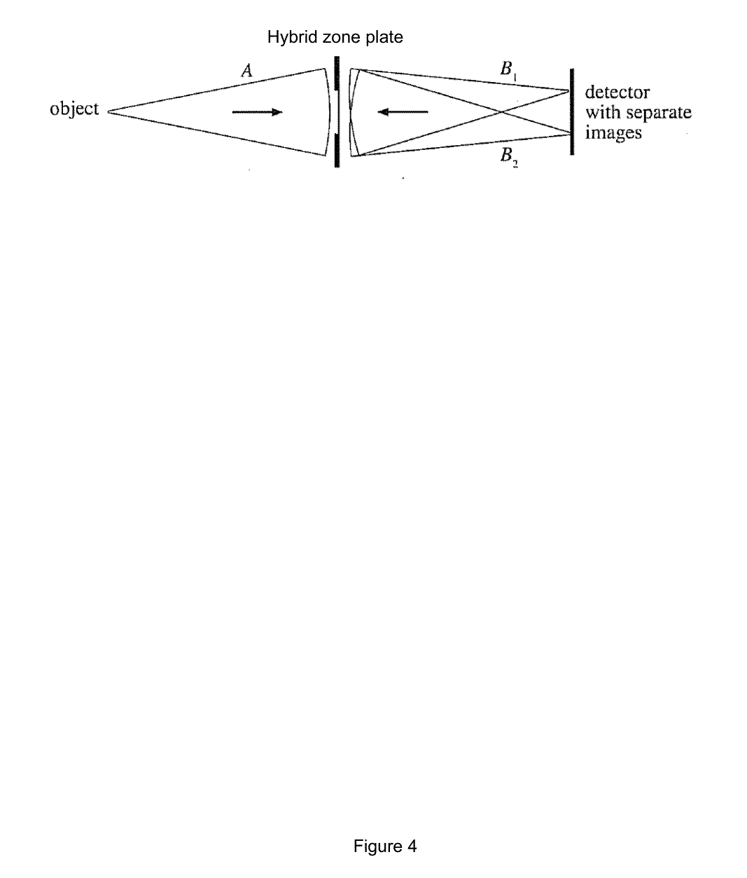

To illustrate the calculation method, consider the example of the schematic drawing of an on-axis version of the hybrid zone plate shown in FIG. 4. The following steps can be used to calculate the hybrid lens pattern deterministically. For a given point P in the lens plane, with in-plane position r, the distance from a central point in the object plane to P is called A(r). Similarly, the distances from P to the central locations of each individual image point are called Bₙ(r), where n=1, 2, 3, . . . . In practice, such an on-axis design may or may not be problematic due to overlapping diffraction orders.

Mathematically, if spherical waves from the object point and from the various image points were allowed to interfere in the lens plane, the intensity of the interference pattern, I(r), with a lens-plane spatial coordinate r could be written as

$$I ( r ) = {\vert {w}_{0} exp [ ikA ( r ) ] + {\sum }_{n = 1}^{N} {w}_{n} exp [ {ikB}_{n} ( r ) ] \vert}^{2} .$$

For generality, weighting factors wₙ have been included in the formulation. In a simple formulation that produces high contrast, w₀=N, and wₙ=1 for all n greater than 0. Other weightings, however, may be useful in different circumstances.

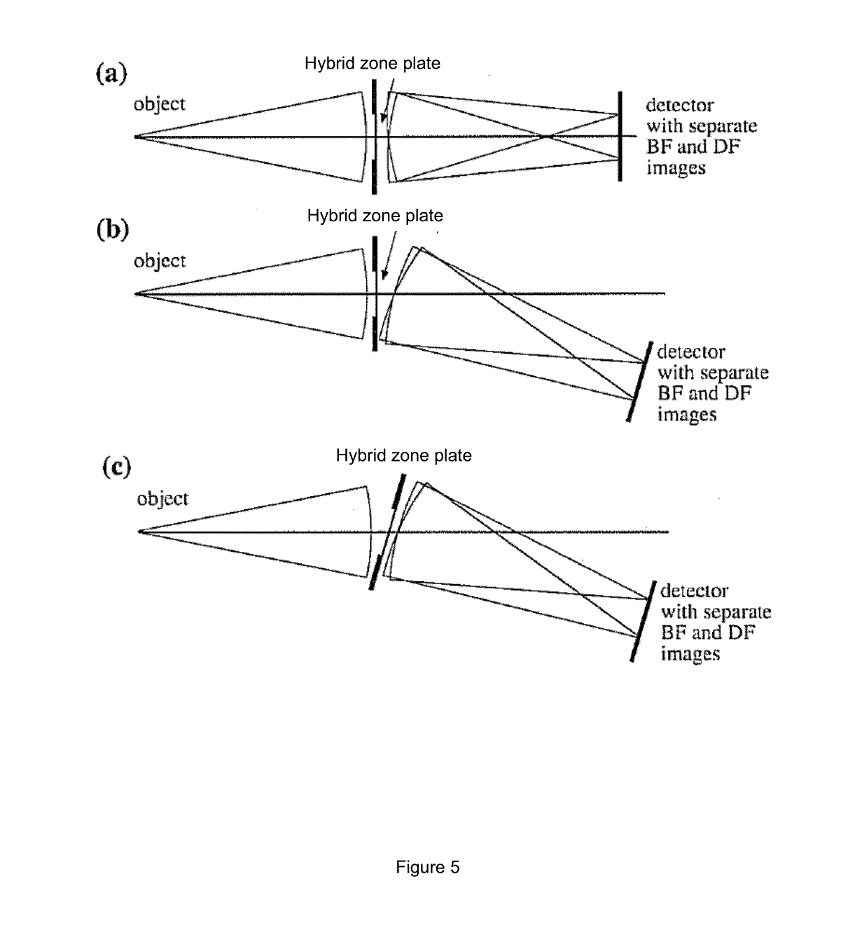

FIG. 5 shows examples of schematic illustrations of geometries of an object, a hybrid zone plate, and a detector. It should be noted that other geometries are possible. As shown in FIG. 5, (a) on-axis geometries, (b) off-axis geometries where the hybrid zone plate is tilted with respect to the detector plane, and (c) off-axis geometries where the hybrid zone plate is parallel to the detector are possible. Note that the object plane may also be inclined. On-axis geometries may require “order sorting” spatial filters to block unwanted diffraction orders from the hologram. In geometries related to EUV mask inspection, the mask (i.e., the object) is typically illuminated several degrees off-axis. Therefore, the object plane may not be vertical in the instances shown in FIG. 5. For relatively small numerical aperture values, the off-axis zone plate geometry may aid in spatially separating the undiffracted zero-order light from the image-forming first order beams in the detector plane.

The following calculations were made for a visible-light analog of the AIT, using smaller magnification ratios, to demonstrate the hybrid zone plate concept. Calculations assume monochromatic, coherent illumination.

TABLE 1
Optical parameters used in the calculations
and examples shown below.

| parameter | Value | |
|---|---|---|
| wavelength, λ | 632.8 | nm |
| Magnification, m | 10× | |
| focal length, f | 10 | mm |

| | |
|---|---|
| NA | 0.06 |
| off-axis angle, θ | 6° |

Each of the following examples includes three images: (1) the hybrid zone plate pattern; (2) the image formed from a point source (i.e., the object), and (3) the image intensity raised to the 0.25 power, to reveal the low-level features.

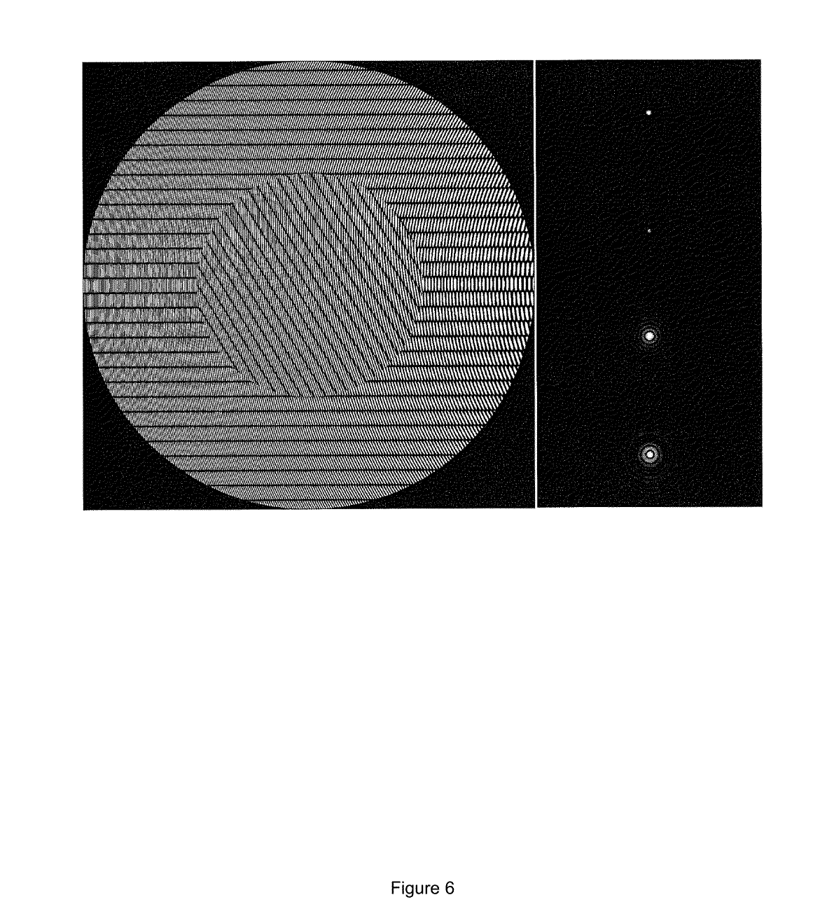

FIG. 6 shows an example of a BF and DF hybrid zone plate configured to generate a deflected central portion and examples of simulated images. Here, three lens patterns overlap. The main BF pattern is projected above the annular-aperture's DF pattern. The central region of the annulus projects a third, low-NA, bright field image up and to the right, far enough to the side that it does not appear on the detector. In this way, each point in the pupil belongs to two sub-lenses.

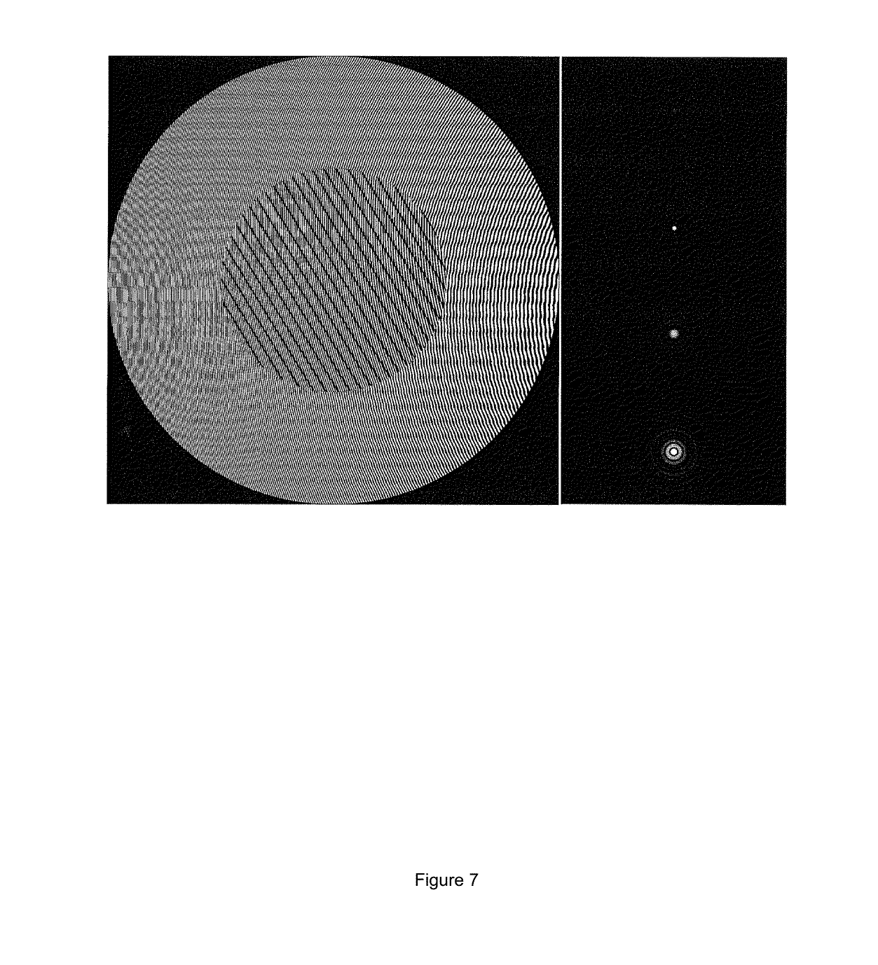

FIG. 7 shows an example of a BF and DF hybrid zone plate configured to generate a deflected central portion and a scaled BF amplitude and examples of simulated images. Similar to the example shown in FIG. 6, three lens patterns overlap. The difference here is that the BF amplitude has been reduced by one-half. Although reducing the BF intensity decreases the BF flux-efficiency of the design, it becomes possible to record both BF and DF images in the same detector exposure with appropriately matched signal levels.

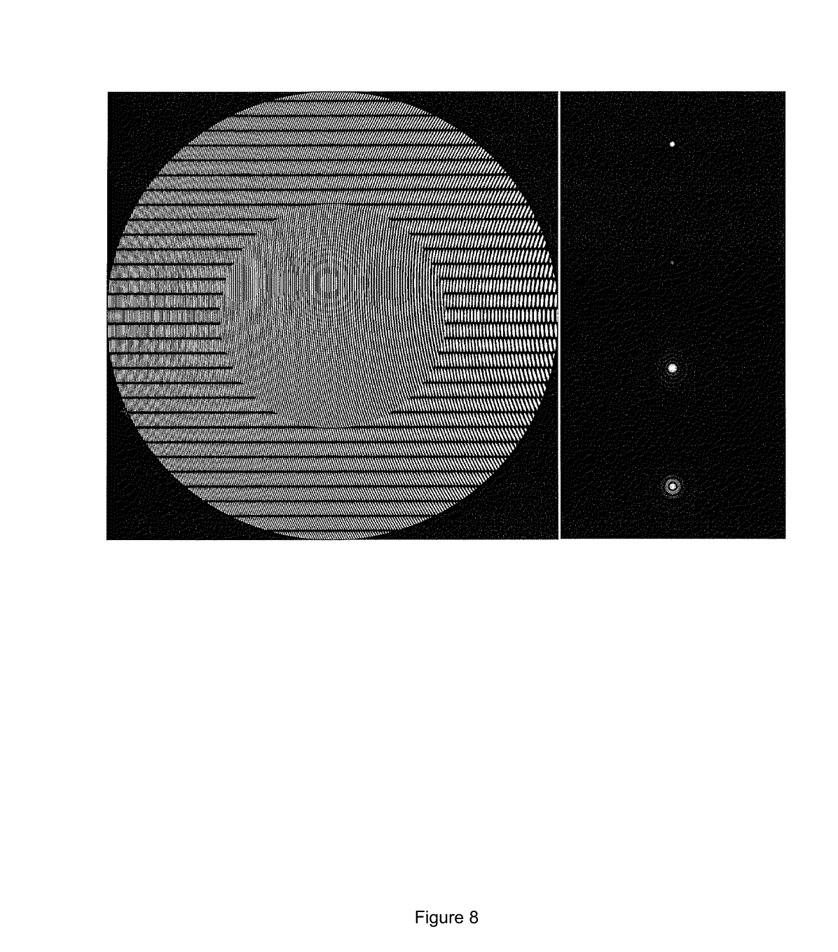

FIG. 8 shows an example of BF and DF hybrid zone plate configured to generate a reduced amplitude in the central portion and examples of simulated images. Here, the hybrid zone plate projects two images. Yet, since the central portion is used for the BF image, the transmission of that region is reduced to balance the intensity across the entire hybrid zone plate. This amplitude reduction occurs as an inherent part of the calculation during the binarization step. Using the calculated intensity interference pattern, the threshold values used for binarization are selected to provide a balanced 50-50 ratio of light to dark pattern regions in the outer, annular region. Because the intensity in the central region represents the interference of two waves, and not three, the intensity mismatch leads to a different dark to light ratio.

From a study of the above-images from the respective hybrid zone plates, there are several considerations that may improve the imaging performance or quality:

Grid displacement. In cases where there are more than two image points (as in FIG. 6 and FIG. 7), an undesirable interference among the various points can arise and position additional weak images where they are not desired. Such interference cannot be avoided, but it can be mitigated by ensuring that the location of the discarded image is far from the other images and does not fall along the same axis.

Phase randomization. Each image can have its own constant phase term, which affects the appearance of the holographic optical elements (HOEs), but does not significantly change the projected image. However, where images do overlap, the phase differences between adjacent images can be controlled to affect the constructive and destructive interferences.

Intensity optimization. As described above regarding the calculation of a hybrid zone plate pattern, when calculating the interference among the various waves, the wave amplitudes should be considered as free parameters subject to optimization. Furthermore, the HOE binarization process can be set as a threshold at an arbitrary intensity level. These free parameters may be optimized, for example, to produce the highest total image flux.

### Example 2

A hybrid zone plate for EUV mask blank inspection using the AIT at Lawrence Berkeley National Laboratory is described below. One function of the hybrid zone plate described below is to simultaneously project multiple images of a single object on a detector in such a way that each image contains different information. The images can be analyzed either as a group or individually.

For the AIT in particular, one limitation of the through-focus data series quality comes from illumination non-uniformities. As the mask is moved longitudinally (through focus), the mask position within the illumination pattern shifts, changing the illumination in the vicinity of the features being imaged. This issue may be addressed by introducing a hybrid zone plate that replaces the zone plate.

In general, given a known illumination pattern, a holographic lens can be designed to project nearly arbitrary fields onto a detector. The zone plate is one simple case of how a holographic lens can operate. One concept described in this example is to change the holographic lens to simultaneously project multiple images onto the detector with some lateral displacement between each image. When the illumination pattern is restricted to a small area around a feature of interest, then the separation between the multiple projected images can help guarantee that the images do not overlap.

The desired properties of each image can be separately designed into the holographic element. For example, when each separate image is assigned a varying amount of defocus, then the projected images will represent a through-focus series captured in just one exposure. In this case the hologram is designed to be the superposition of multiple lenses with slightly different focal lengths (e.g., to generate the focal series) and tilts (e.g., to separate the images on the detector). Each of the sub-lenses can share the same numerical aperture of the full pupil because rather than existing side-by-side in the lens area, they fully overlap.

Such a hybrid zone plate has several benefits for EUV mask inspection, including:

A. Illumination uniformity or consistency. Since the multiple images projected by the hybrid zone plate all come from a single illuminated object, the data in the through-focus series is much less susceptible to the variations in illumination uniformity that occur when the series is collected mechanically. That is, the image-to-image illumination non-uniformities that arise in manual or automatic through-focus data collection can be overcome.

B. Data collection throughput. In principle, the hybrid zone plate could increase the data throughput by almost 2 times in the AIT, or more. This is because it removes the current need for a waiting time during which the mechanical stages settle and stabilize between images. However, the conservation of energy principle dictates that as the image is split into multiple parts, the intensity of each sub-image will scale accordingly. Image intensity with a hybrid zone plate scales as the reciprocal of the number of individual sub-images projected. Therefore, hybrid zone plate that projects 10 images, for example, would require a 10 times longer exposure time to achieve the same signal level.

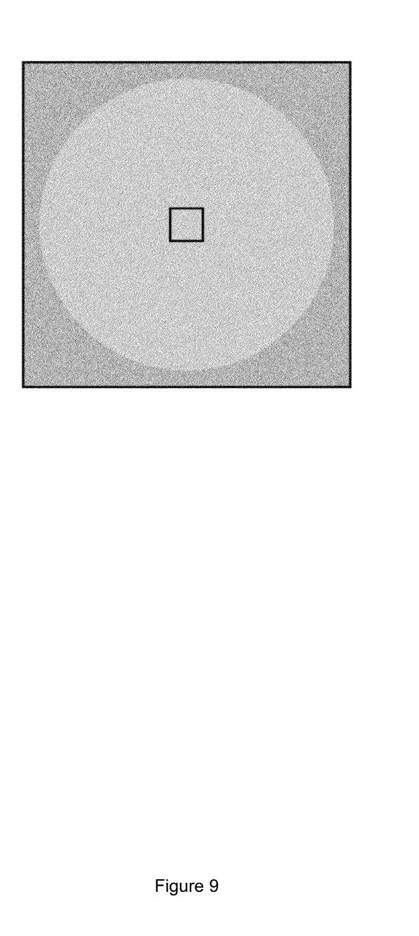

C. Field of view considerations. In the AIT, a small region within the full images is used for data analysis. The current configuration of the AIT projects a field of view that is about 30 microns wide; however, various considerations limit the usable field of view to about 2 microns to 5 microns near the center of the image. The rest of the image is not considered except for navigation. FIG. 9 shows an example of an illustration of the full image area recorded by a detector (the large square), the illuminated portion (the light circle), and the useful data region, at the center.

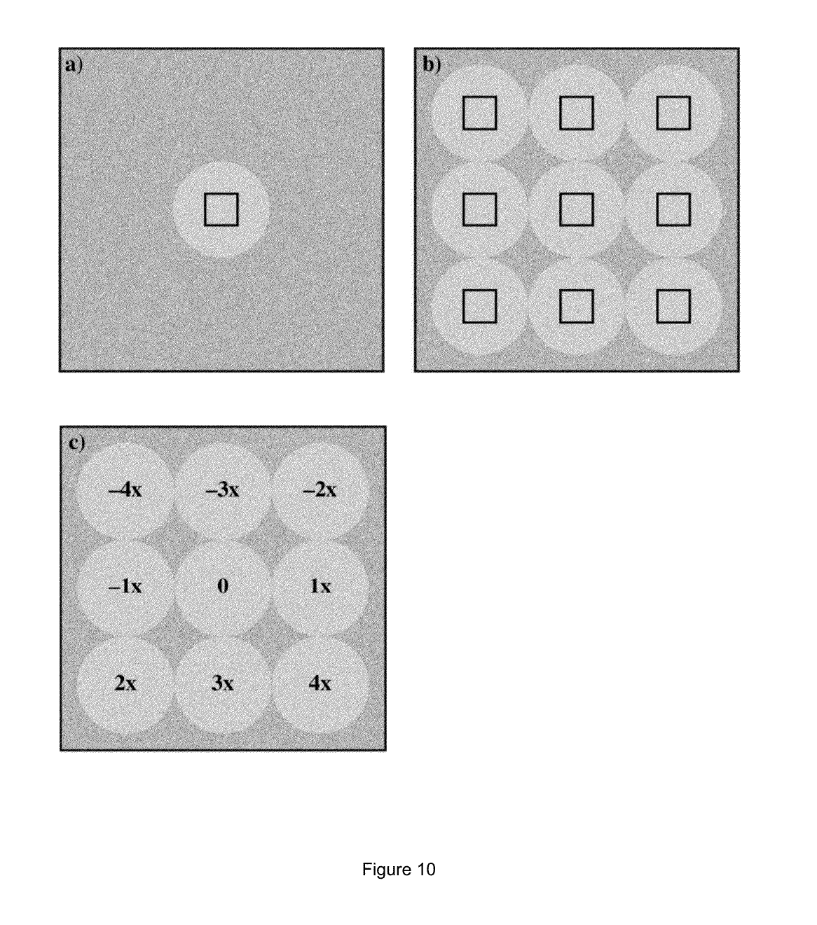

For a hybrid zone plate, the illuminated area can be restricted to a few microns. The hybrid zone plate projects multiple displaced images onto the detector in such a way that they are physically separate and do not overlap across the region of interest. The pattern could be a grid, as shown in FIG. 10, or it could be any convenient layout. FIG. 10 shows examples of illustrations to aid in understanding the hybrid zone plate: (a) concentrate the illumination onto a small region of the object (e.g., the mask); (b) the hybrid zone plate projects multiple displaced images at once onto the detector—here nine images are shown, but the actual number is arbitrary; and (c) by assigning each lens a given defocus magnitude in the hybrid zone plate design, an entire through-focus series in a single image can be recorded.

Some holographic elements require complex mathematical algorithms to produce. In contrast, a hybrid zone plate pattern may be calculated deterministically, based on the object and image positions and the desired defocus magnitudes. Following the holographic principle, the calculation mathematically determines the interference pattern that would be formed in the lens plane if each of the projected images were back-propagated to that plane and were allowed to interfere with a single spherical wave emanating from the object position. The relative weighting (i.e., amplitude) of the object wave can be selected to optimize the image intensity. Once the interference has been calculated, the pattern can be binarized for fabrication, if needed.

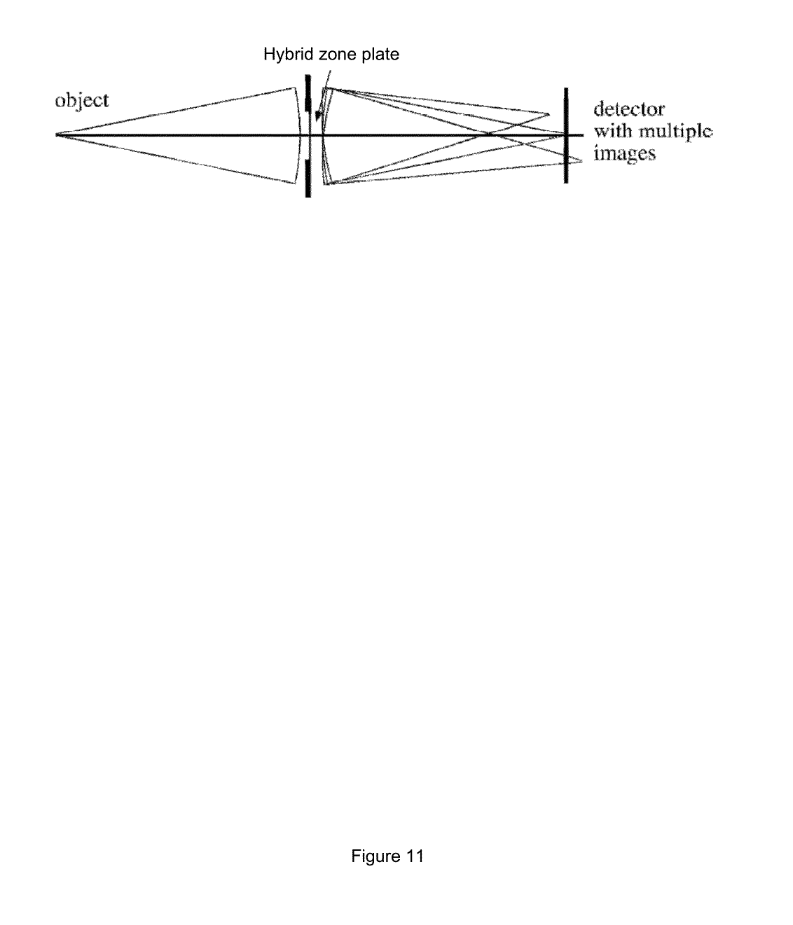

FIG. 11 shows an example of a schematic illustration of an on-axis version of the hybrid zone plate. The following steps can be used to calculate the hybrid zone plate pattern deterministically. For a given point P in the lens plane, with in-plane position r, the distance from a central point in the object plane to P is called A(r). Similarly, the distances from P to the central locations of each individual image points is are called Bₙ(r), where n=1, 2, 3, . . . .

Mathematically, if spherical waves from the object point and from the various image points were allowed to interfere in the lens plane, the intensity of the interference pattern, I(r), could be written as

$$I ( r ) = {\vert {w}_{0} exp [ ikA ( r ) ] + {\sum }_{n = 1}^{N} {w}_{n} exp [ {ikB}_{n} ( r ) ] \vert}^{2} .$$

For generality, weighting factors wₙ have been included in the formulation. In a simple formulation that produces high contrast, w₀=N, and wₙ=1 for all n greater than 0. However, other weightings may prove useful in different circumstances. The weighting factors can be complex values that impart a constant phase term to the wave.

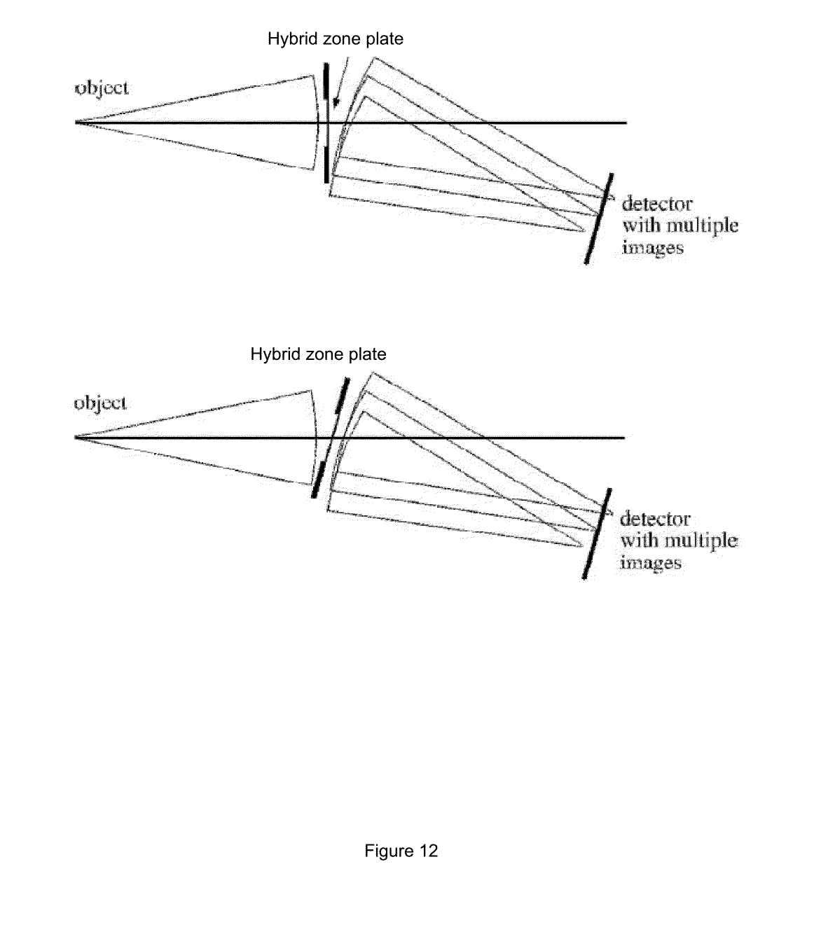

While there may be numerous variations on a hybrid zone plate, there are a few configurations relating to the positions and angles of the three primary elements: object, hybrid zone plate, and detector. Two examples are shown FIG. 12, and one example is shown in FIG. 11. Note that on-axis geometries may require “order sorting” spatial filters to block unwanted diffraction orders from the hologram.

The off-axis geometry of the AIT, as shown in FIG. 12, separates the zeroth-order undiffracted light from the first order focused light of the image, allowing the hybrid zone plate to be used without an order sorting aperture. Note that while a single object point is shown, the object plane may also be inclined. In off-axis geometries, the hybrid zone plate plane may be parallel to the object plane, or tilted, depending on the illumination conditions.

The following calculations were made for a visible-light analog of the AIT, using smaller magnification ratios, as a means to demonstrate a hybrid zone plate. The calculations assume monochromatic, coherent illumination. The same optical parameters as used in the calculations in EXAMPLE 1 were used in these calculations. Each of the following examples includes three images: (1) the hybrid zone plate pattern; (2) the image formed from a point source (object), and (3) the image intensity raised to the 0.25 power, to reveal the low-level features.

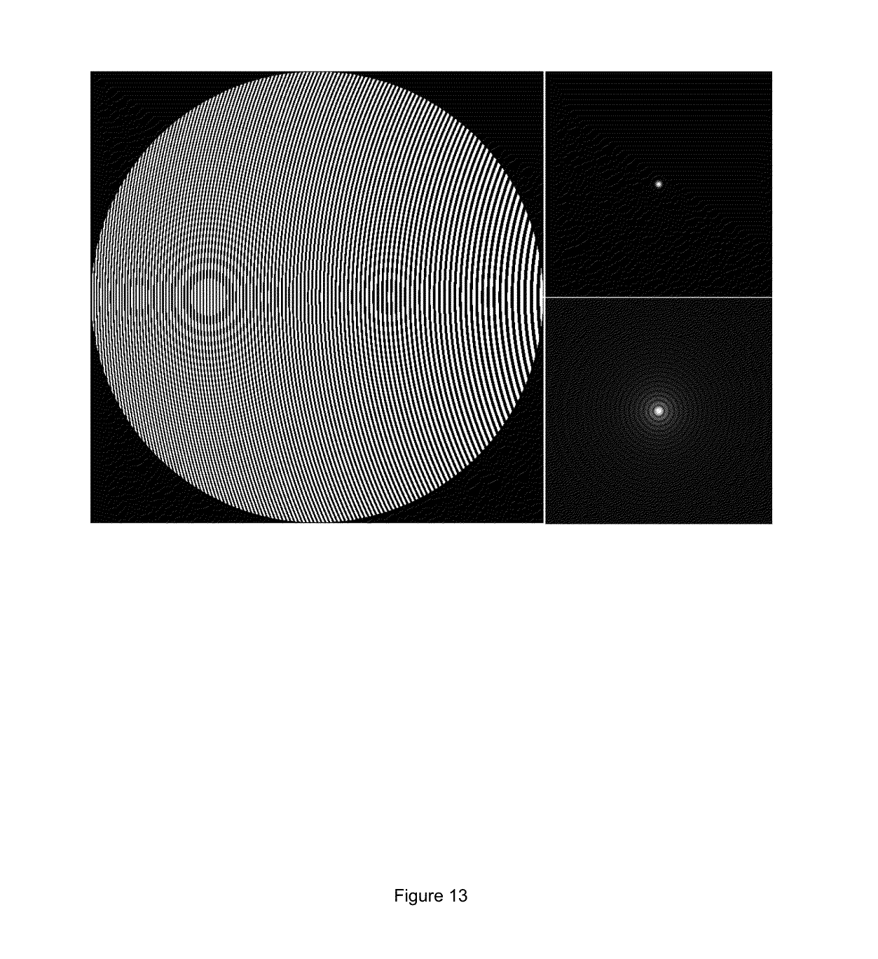

FIG. 13 shows an example of a basic off-axis zone plate and examples of simulated images. This represents a system similar to the current configuration in the AIT. An object point source on the mask will form an Airy pattern image on the detector.

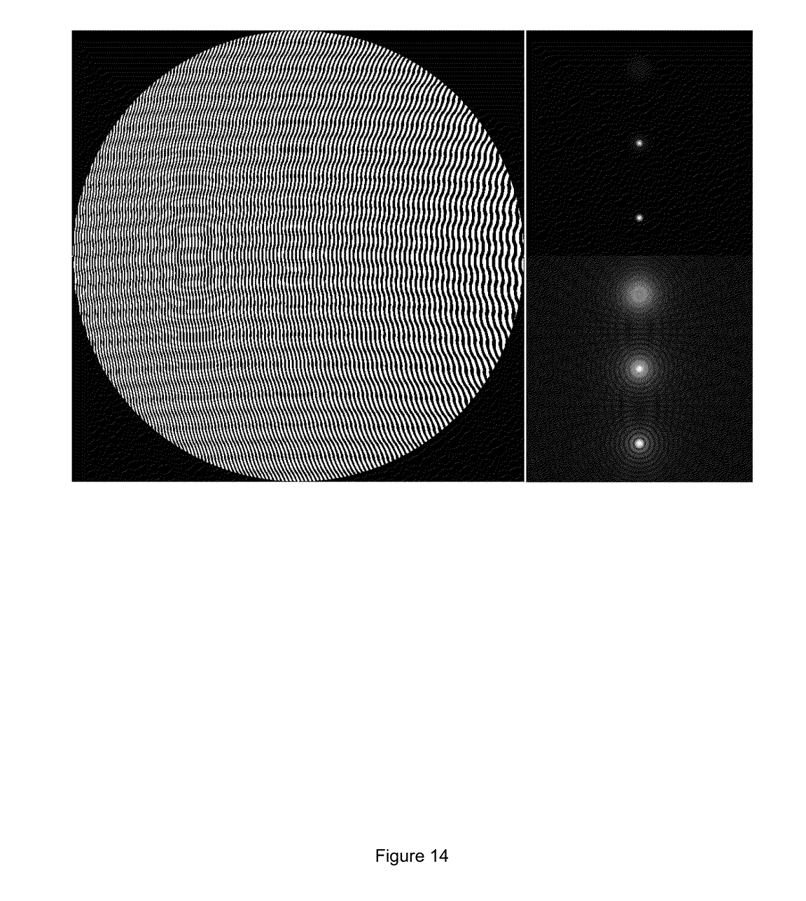

FIG. 14 shows an example of a hybrid zone plate configured to generate three images with vertical displacement and defocus and examples of simulated images. The lower image is at best focus, while the two images above it have increasing defocus. A single point source produces these three images.

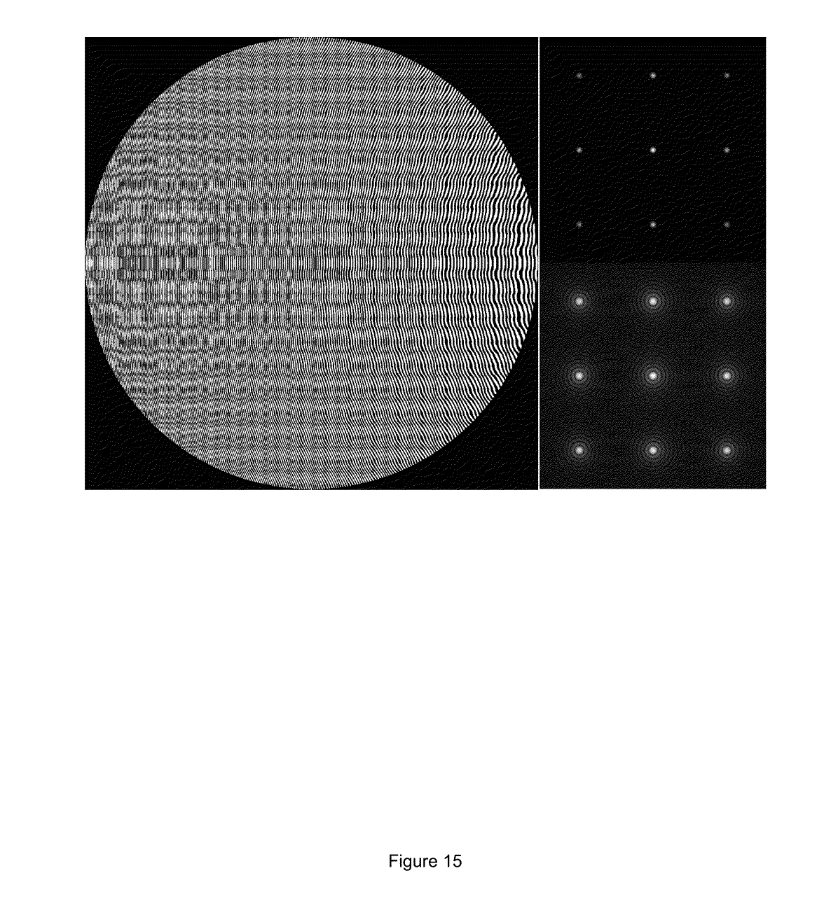

FIG. 15 shows an example of a hybrid zone plate configured to generate nine images with grid displacement and fixed focus and examples of simulated images. Each image is projected at best focus. When the hybrid zone plate images form a regular grid, interference between the individual patterns can have an adverse effect on the resulting images. More generally, if the displacement (i.e., Δx, Δy), between any two points is repeated, unwanted internal interference terms may arise. To mitigate this predictable effect, it may be useful to displace each point from its position on a regular grid in such a way that no two displacements are the same. This is the meaning of “grid displacement” as used the figure descriptions.

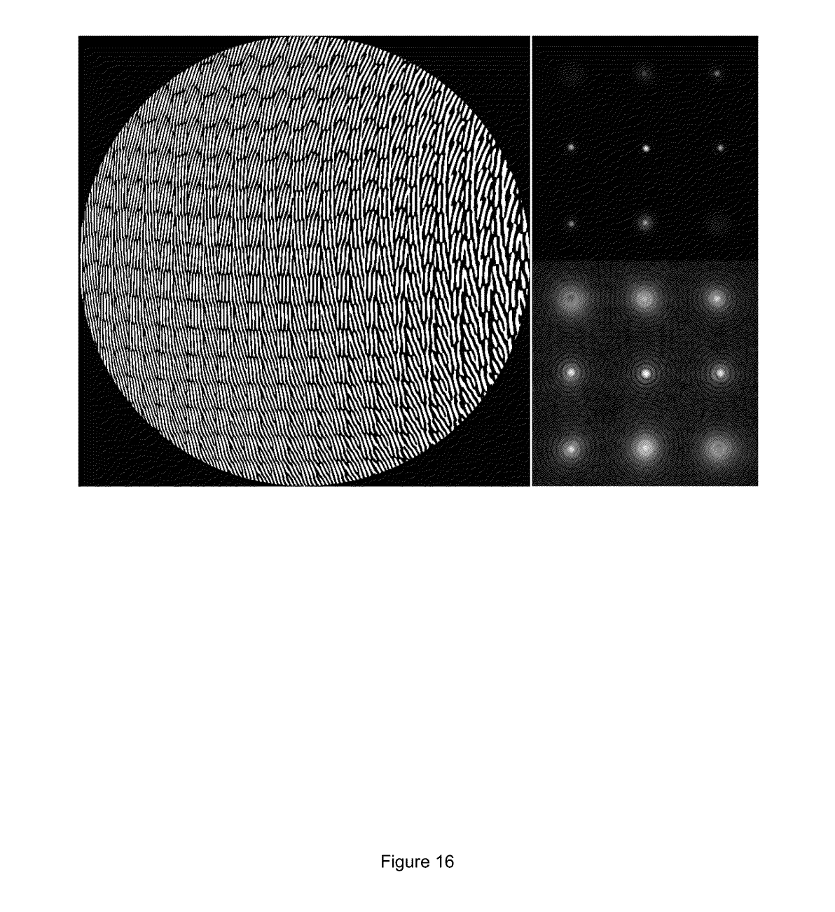

FIG. 16 shows an example of a hybrid zone plate configured to generate nine images with grid displacement and varying focus and examples of simulated images. The image at best focus is at the center, while those above and below it, have increasing defocus magnitudes in the two directions.

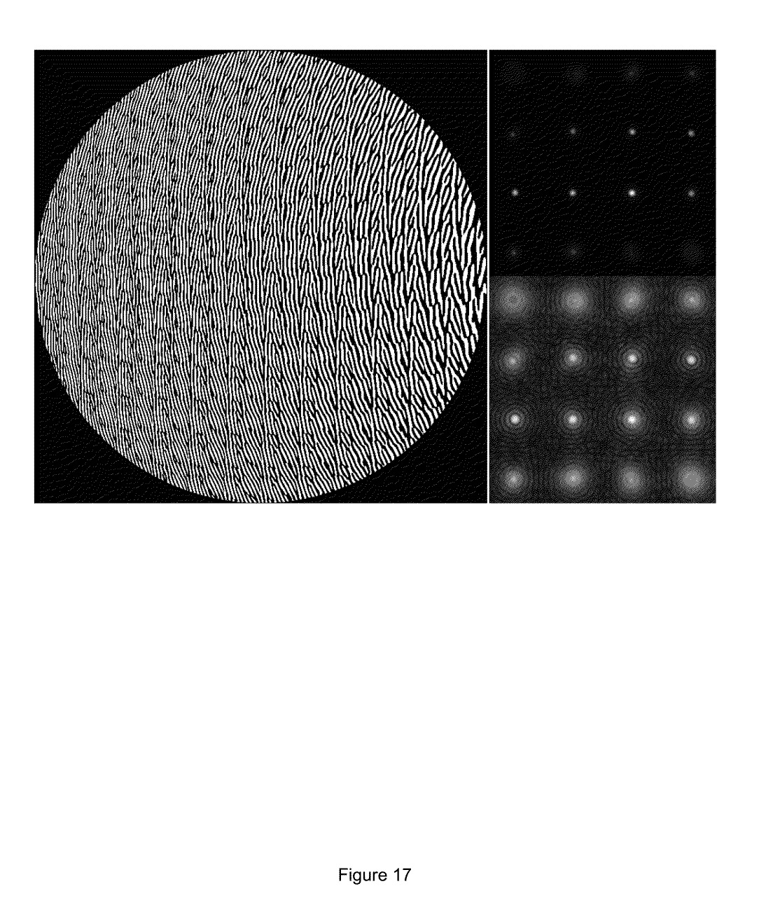

FIG. 17 shows an example of a hybrid zone plate configured to generate sixteen images with grid displacement and varying focus and examples of simulated images. The image at best focus is on the left in the third row.

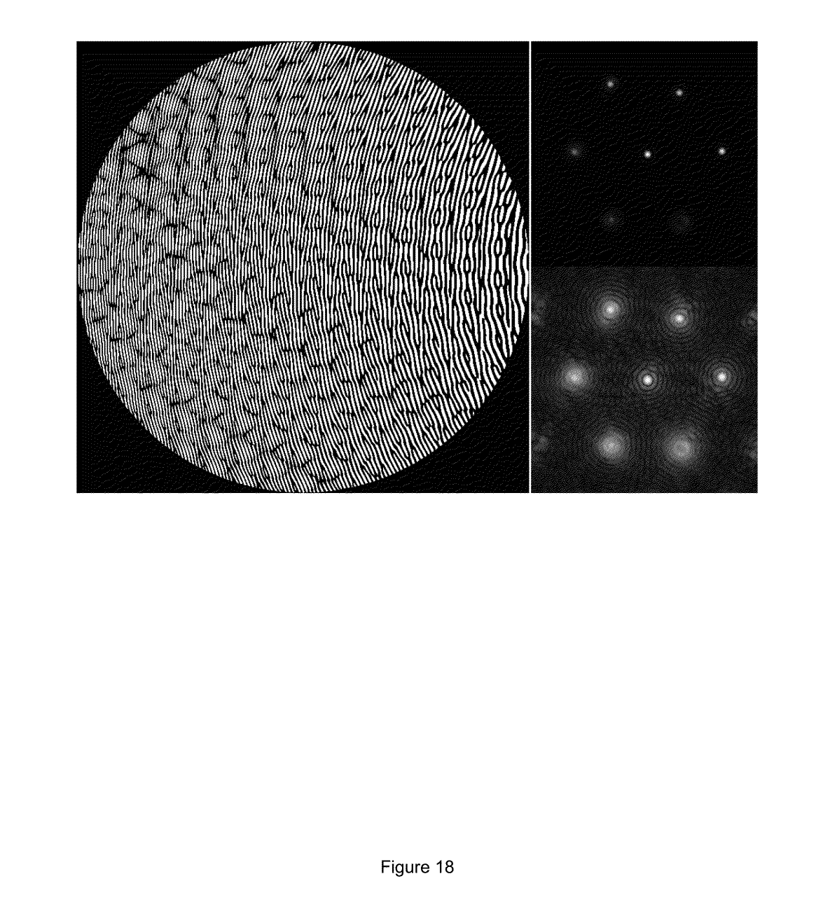

FIG. 18 shows an example of a hybrid zone plate configured to generate seven images with hexagonal grid displacement and varying focus and examples of simulated images. The image at best focus is at the center, and defocus increases counter-clockwise from the rightmost point. The image positions were displaced randomly from a simple hexagonal grid to suppress the additional orders that appear outside of the seven primary positions.

From a study of the above-images from the respective hybrid zone plates, there are several considerations that may improve the imaging performance or quality:

Grid displacement. As described with respect to FIG. 15, when the image points are designed to fall on a regularly spaced grid, there could be unintended interference between the different images. One way to mitigate this potential issue is to slightly displace the images from a regular grid, ensuring that no two images share the same relative displacement vector.

Phase randomization. Each image can have its own constant phase term, which affects the appearance of the HOE, but does not significantly change the projected image. However, where images do overlap, the phase differences between adjacent images can be controlled to affect the constructive and destructive interferences.

Intensity optimization. When calculating the interference among the various waves, the wave amplitudes should be considered as free parameters, subject to optimization. Furthermore, the intensity threshold level used in the hybrid zone plate binarization process can also be optimized. The merit function used in the optimization may be selected in any desired manner, for example, to produce the highest image intensity.

### CONCLUSION

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. An optical device comprising:
an imaging element configured to interact with electromagnetic radiation of specific wavelengths and configured to divide a first wavefront of the electromagnetic radiation into a plurality of separate wavefronts, each of the plurality of separate wavefronts including imaging information of an object configured to generate an image of the object, each of the images of the object having different properties compared to other images.

2. The optical device of claim 1, wherein each of the plurality of separate wavefronts is spatially separated when projected onto a detector.

3. The optical device of claim 1, wherein a first of the plurality of separate wavefronts includes bright field imaging information configured to generate a bright field image of the object, and wherein a second of the plurality of separate wavefronts includes dark field imaging information configured to generate a dark field image of the object.

4. The optical device of claim 1, wherein each of the plurality of separate wavefronts includes imaging information at different defocus values configured to generate a plurality of images of the object at different defocus values.

5. The optical device of claim 1, wherein the imaging element comprises a holographic imaging element.

6. The optical device of claim 1, wherein the imaging element comprises a holographic imaging element combined with a lens in a single device.

7. The optical device of claim 1, wherein the imaging element comprises a hybrid zone plate.

8. The optical device of claim 7, wherein the hybrid zone plate includes a plurality of overlapping lens patterns.

9. The optical device of claim 8, wherein each of the plurality of overlapping lens patterns generates one of the plurality of separate wavefronts.

10. A system comprising:
an electromagnetic radiation source, the electromagnetic radiation source configured to generate electromagnetic radiation;
a detector; and
an imaging element, the imaging element configured to simultaneously project a plurality of images of an object onto the detector after the electromagnetic radiation interacts with the object, each of the plurality of images of the object having different properties from others of the plurality of images.

11. The system of claim 10, wherein the imaging element is configured to divide a first wavefront of the electromagnetic radiation into a plurality of separate wavefronts, and wherein each of the plurality of separate wavefronts generates each of the plurality of images of the object.

12. The system of claim 11, wherein each of the plurality of separate wavefronts includes different imaging information of the object.

13. The system of claim 12, wherein a first of the plurality of separate wavefronts includes bright field imaging information configured to generate a bright field image of the object on the detector, and wherein a second of the plurality of separate wavefronts includes dark field imaging information configured to generate a dark field image of the object on the detector.

14. The system of claim 12, wherein each of the plurality of separate wavefronts includes imaging information at a different defocus value configured to generate a plurality of images of the object at different defocus values on the detector.

15. The system of claim 10, wherein the imaging element is incorporated with a zone plate or a lens in a single element.

16. The system of claim 10, wherein the imaging element comprises a zone plate and includes a plurality of overlapping lens patterns.

17. The system of claim 16, wherein each of the plurality of overlapping lens patterns generates one of the plurality of images of the object.

18. The system of claim 11, wherein the imaging element is configured to project each of the plurality of images of the object onto a separate region of the detector.

19. The system of claim 10, wherein the plurality of images includes a bright field image and a dark field image of the object.

20. The system of claim 10, wherein each image of the plurality of images is at a different defocus value.
